(19) United States
(12) Patent Application Publication
(10) Pub. No.: US 2012/0120497 A1
(43) Pub. Date: May 17, 2012

(54) APPARATUS FOR COVERING AN OPTICAL SENSOR DISPOSED IN FRONT OF AN ELECTRONIC DISPLAY FOR SENSING A VISUAL VERIFICATION SIGNAL

(76) Inventors: Peter Daly, Yorktown Heights, NY (US); Mikhail Marsky, Ramsey, NJ (US); Robert Wolinsky, Fairfield, CT (US)

(21) Appl. No.: 13/298,733

(22) Filed: Nov. 17, 2011

Related U.S. Application Data
(60) Provisional application No. 61/414,816, filed on Nov. 17, 2010.

(51) Int. Cl. G02B 27/00; H01J 9/00

(52) U.S. Cl. 359/601; 445/24

(57) ABSTRACT

An electronic display including a screen including an outer perimeter and front surface. A housing including a screen frame may surround the outer perimeter, and extend in front of the front surface of the screen. An optical sensor shield may be positioned at least in part in the screen frame and extend in front of the front surface of the screen.

### RELATED APPLICATIONS

This Application claims priority to co-pending U.S. Provisional Patent Application Ser. No. 61/414,816, filed Nov. 17, 2011, entitled “APPARATUS FOR COVERING AN OPTICAL SENSOR DISPOSED IN FRONT OF AN ELECTRONIC DISPLAY FOR SENSING A VISUAL VERIFICATION SIGNAL”, the contents of which are hereby incorporated by reference in their entirety.

### BACKGROUND

A visual verification signal displayed on an electronic display may be measured to determine whether content is timely and correctly displayed. The measurement of visual verification signals can be problematic due to ambient light being imaged onto an optical sensor being used to sense the visual verification signals.

### SUMMARY

To overcome the problem of ambient light illuminating an optical sensor being used to sense a visual verification signal, the principles of the present invention provide for an optical sensor shield to be integrated with a housing of an electronic display to cover the optical sensor positioned in front of a screen of the electronic display. In one embodiment, the optical sensor may be positioned in a corner of the electronic display and the optical sensor shield may extend from the electronic display housing. In one embodiment, the optical sensor shield may be circular and a sector of the shield may extend over the electronic display screen.

An electronic display including a screen including an outer perimeter and front surface. A housing including a screen frame may surround the outer perimeter, and extend in front of the front surface of the screen. An optical sensor shield may be positioned at least in part in the screen frame and extend in front of the front surface of the screen.

A method for displaying a visual verification signal may include designating a plurality of pixels of a screen that are positioned below and immediately adjacent to an outer perimeter of an optical sensor shield. A visual verification signal may be displayed in the designated pixels.

A method of manufacturing an electronic display may include providing a housing, providing a screen frame, providing an optical sensor shield, and providing an electronic display screen. The housing, screen frame, optical sensor shield, and electronic display screen may be assembled to form the electronic display.

The electronic display may further include ornamental features as provided herein. The visual verification signal may also have ornamental features as shown herein, and in conjunction with the ornamental features of the optical sensor shield.

### BRIEF DESCRIPTION OF THE DRAWINGS

FIG. 1 is an illustration of a front view of an illustrative electronic display including a housing with an illustrative optical sensor shield;

FIG. 2 is an illustration of a perspective view of the electronic display that shows the optical sensor shield extending over the screen;

FIGS. 3 and 4 are illustrations of opposing side views of the illustrative electronic display mounted within a support frame;

FIG. 5 is an illustration of a front view of the electronic display shown a sectional view line A-A that is presented in FIG. 6;

FIG. 6 is a sectional view A-A of the electronic display as defined in FIG. 5 and shows that the optical sensor shield extends slightly beyond the screen frame;

FIG. 7 is an illustration of a top view of the electronic display showing the optical sensor shield extending slightly forward of the screen frame;

FIG. 8 is an illustration of a front view of the electronic display as shown in FIG. 1;

FIG. 9 is an illustration of a magnified view of the optical sensor shield;

FIG. 10 is an illustration of a bottom perspective view of the housing of FIG. 1 that includes the optical sensor shield and screen frame;

FIG. 11 is an illustration of a top isometric view of the housing of FIG. 1 that includes the optical sensor shield and support frame, as described with regard to FIG. 10.

FIG. 12 is an illustration of a front view of the electronic display of FIG. 1.

### DETAILED DESCRIPTION OF THE DRAWINGS

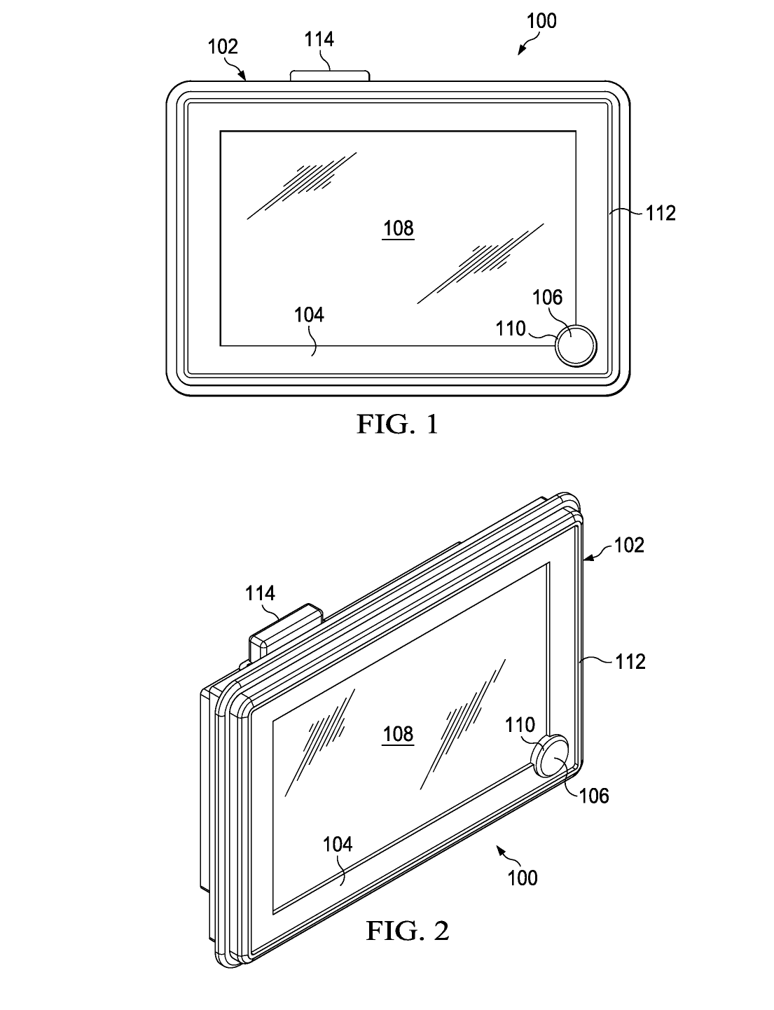

FIG. 1 is an illustration of a front view of an illustrative electronic display 100 including a housing 102. The housing 102 includes a screen frame 104 in which an optical sensor shield 106 is integrated. Being integrated means that the optical sensor shield 106 may be formed as part of or attached to the screen frame 104. The integration may be performed using the same manufacturing process as performed for making the screen frame 104. Alternatively, a different manufacturing process or the same manufacturing process to form a separate component may be used and attachment elements may be included on the screen frame 104 and corresponding attachment elements may be included on the optical sensor shield 106. In one embodiment, the manufacturing process is a plastics molding process.

As shown, the optical sensor shield 106 extends over a screen 108 of the electronic display 100. Although shown in a circle configuration, the optical sensor shield 106 may be any shape. By using a circular shape, an ornamental design is provided. As can be seen, the optical sensor shield 106 includes a bevel 110 between the front surface and outside surface, thereby giving a suspended look to the optical sensor shield 106. The housing 102 may further includes a border region 112 that frames the screen border 104. In one embodiment, the optical sensor shield 106 and the border region 112 may be approximately the same color so as to provide an ornamental design that is “clean” in nature. Different or matching colors may be utilized, as well. In one embodiment, the housing 102 may extend beyond the border region 112 and be approximately the same color as the screen border 104, thereby maintaining the “clean” ornamental design. An antenna cover 114 is shown to extend along the top edge of the housing 102 of the electronic display 102, and may be configured to cover an antenna (not shown) that is positioned within the antenna cover 114. Accordingly, the antenna cover 114 may be at least partially hollow to allow the antenna to extend from the housing 102. Other shapes and configurations of an antenna cover may be utilized, including not showing an antenna cover at all. The shape of the antenna cover 114 provides for a distinct ornamental feature.

FIG. 2 is an illustration of a perspective view of the electronic display 100 that shows the optical sensor shield 106 extending over the screen 108. In one embodiment, the optical sensor shield 106 may have a flat front surface. Alternatively, the optical sensor shield 106 may have a non-flat surface, such as a concave or convex surface. In addition, the front surface of the optical sensor shield 106 may be coplanar with the front surface of the screen frame 104. Alternatively, the front surfaces of the optical sensor shield 106 and frame screen 104 are not coplanar.

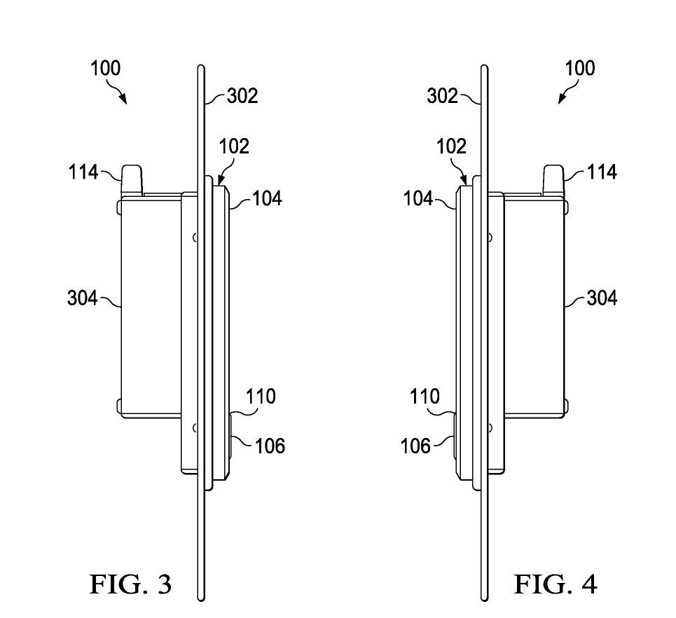

FIGS. 3 and 4 are illustrations of opposing side views of the illustrative electronic display 100 mounted within a support frame 302. As shown, the optical sensor shield 106 has a non-coplanar profile with the screen frame 104. A rear housing 304 is used to position and secure electronics used to display content, collect content certification information, communicate wireless and/or wired signals, and so on.

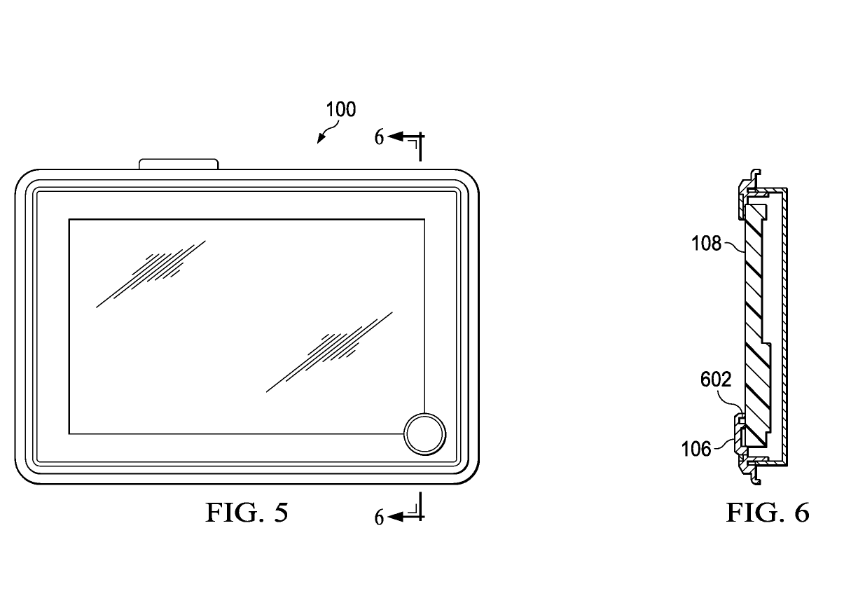

FIG. 5 is an illustration of a front view of the electronic display 100 shown a sectional view line A-A that is presented in FIG. 6.

FIG. 6 is a sectional view A-A of the electronic display 100 as defined in FIG. 5 and shows that the optical sensor shield 106 extends slightly beyond the screen frame 104. The optical sensor shield 106 may further includes a divider structural member 602 that defines a path through which a wire (not shown) may extend to enable electrical signals to pass to an optical sensor (not shown) that is positioned in front of the screen 108. The optical sensor may be fixedly positioned within the optical sensor shield 106 or be mounted to the screen 108 using an adhesive.

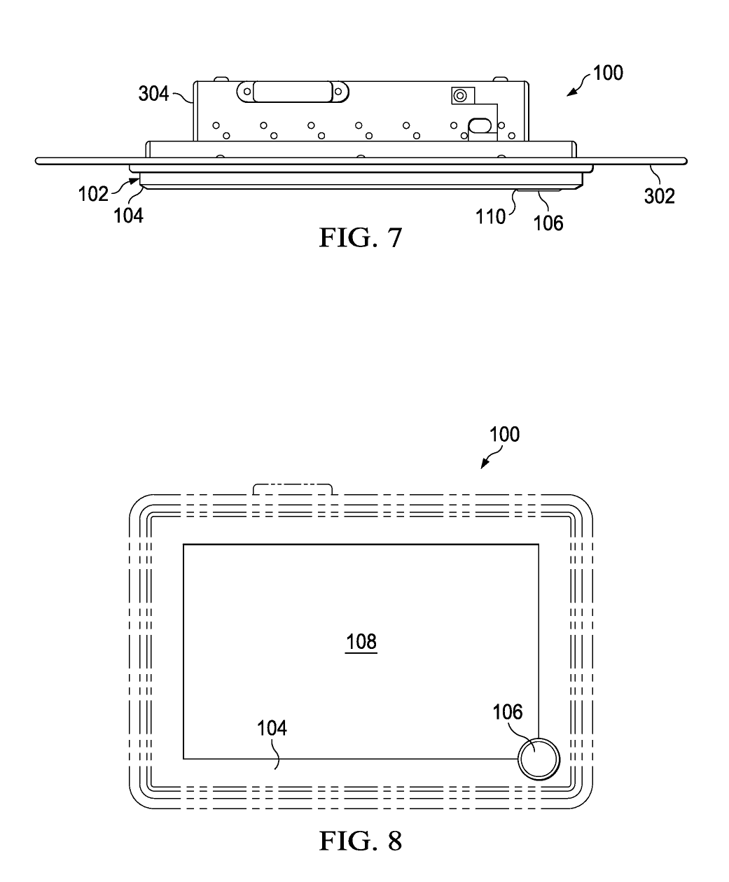

FIG. 7 is an illustration of a top view of the electronic display 100 showing the optical sensor shield 106 extending slightly forward of the screen frame 104. The electronic display 100 is shown to include the housing 304 that extends behind the screen frame 104. The housing 304 supports and houses electronic printed circuit boards that may perform computing, display, and communications functionality. It should be understood that the actual and relative dimensions shown in FIG. 7 and other figures are illustrative and that alternative dimensions may be utilized in accordance with the principles of the present invention.

FIG. 8 is an illustration of a front view of the electronic display 100 as shown in FIG. 1. However, because the ornamental feature of the screen frame 104 and optical sensor shield 106 are primarily provided by those two elements, the other lines and surfaces of the electronic display 100 are shown as dashed lines to represent the environment in which the ornamental feature resides. It should be understood that other angular views of the electronic display 100 may also have dashed lines that represent the environment in which the screen frame 104 and optical sensor shield 106 reside. Although the screen frame 104 is shown as a rectangular shape, it should be understood that rounded corners, square shape, or other deviations may be made and be considered to be the same or analogous as the principles of the present invention. Furthermore, although shown as being positioned within the lower right-hand corner, it should be understood that the optical sensor shield 106 may be positioned anywhere along the edge of the screen 108. However, by placing the optical sensor shield 106 in the corner and displaying the visual verification signal on pixels beneath the optical sensor shield 106 or in slight view of a viewer (see FIG. 12), there is minimal intrusion of the visual verification signal in the viewable area. The visual verification signal may use the principles described in U.S. Pat. No. 7,614,065 which are incorporated herein by reference in their entirety.

FIG. 9 is an illustration of a magnified view of the optical sensor shield 106. As shown, the optical sensor shield 106 covers a portion of the screen 108. The optical sensor shield 106 includes a bevel 110 that provides a visual appearance of the optical sensor shield 106 floating. As can be seen, the screen frame 104 includes border region 112. In one embodiment, the border region 112 may have a triangular profile so that some level of texture is given to the border region 112. Alternatively, the border region 112 may be flat or have another profile shape.

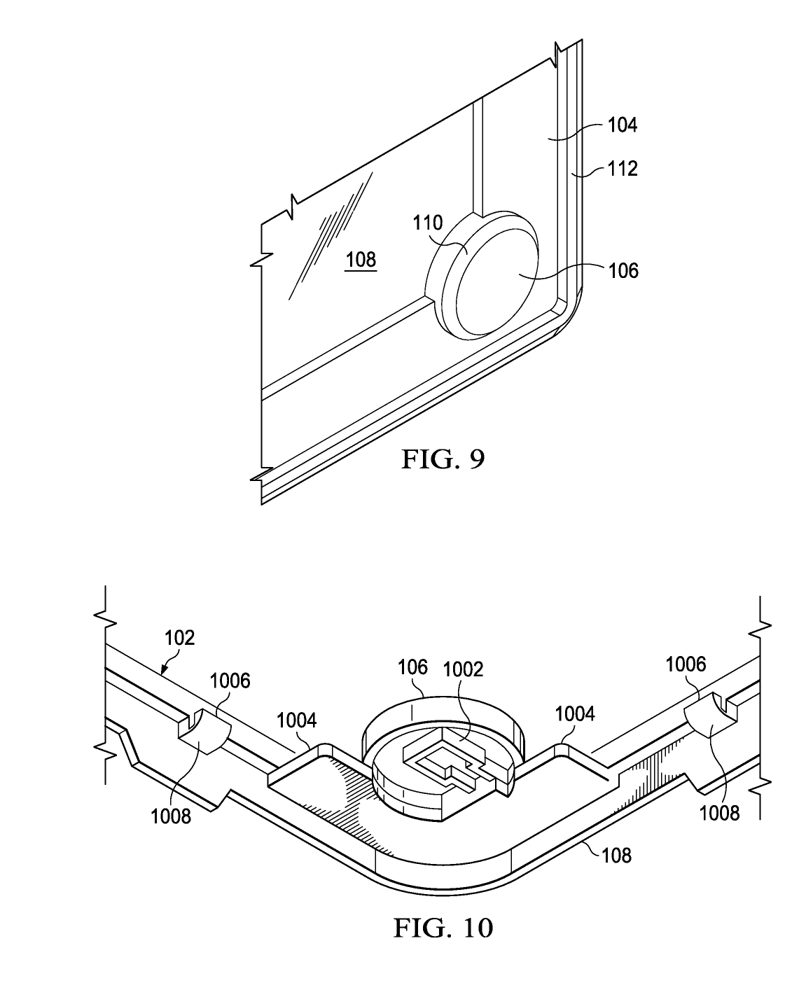

FIG. 10 is an illustration of a bottom perspective view of the housing 102 (FIG. 1) that includes the optical sensor shield 106 and screen frame (not shown). The optical sensor shield 106 is shown to include some structural members 1002 that provides strength, but reduces the weight and material used for creating the optical sensor shield 106. The optical sensor shield 106 may be formed of plastic and be injection molded along with the screen frame 104. The structural members 1002 may be configured to enable an optical sensor (not shown) that is mounted to the screen to not be in contact with the optical sensor shield 106. Alternatively, the structural members 1002 of the optical sensor shield 106 may provide for an optical sensor to be mounted to the optical sensor shield 106. In either case, the structural members 1002 may be configured in such a manner that one or more electrical conductors (e.g., wires) may pass beneath the optical sensor shield 106 and the screen frame 104 so that signals generated by the optical sensor as a result of sensing optical images displayed on the screen may be communicated to a processing unit within the electronic display.

As further shown, the optical sensor shield 106 may be part of or mounted to a support frame 1002. The optical sensor shield 106 may include or be connected to connector members 1004 that are used to provide support for the optical sensor shield. The connection may be performed using an adhesive, snap, hardware (e.g., screws), or any other connection mechanism. Furthermore, the connector members 1004 may be configured to have a thickness that allows a screen to be clamped between the connector members 1004 and brackets 1006 that are part of the support frame 1002. As shown, the brackets 1006 are extended below the surface of the support frame 1002 and have a shelf 1008 that is used to support a screen. The support frame 1002 may be positioned underneath the screen frame 104 so as to not be seen externally, as provided by FIG. 9. It should be understood that rather than the support frame 1002 being independent from the screen frame 104 that the two frames 1002 and 104 may be integrated into a single component. It should further be understood that alternative configurations for supporting the screen may be utilized in accordance with the principles of the present invention.

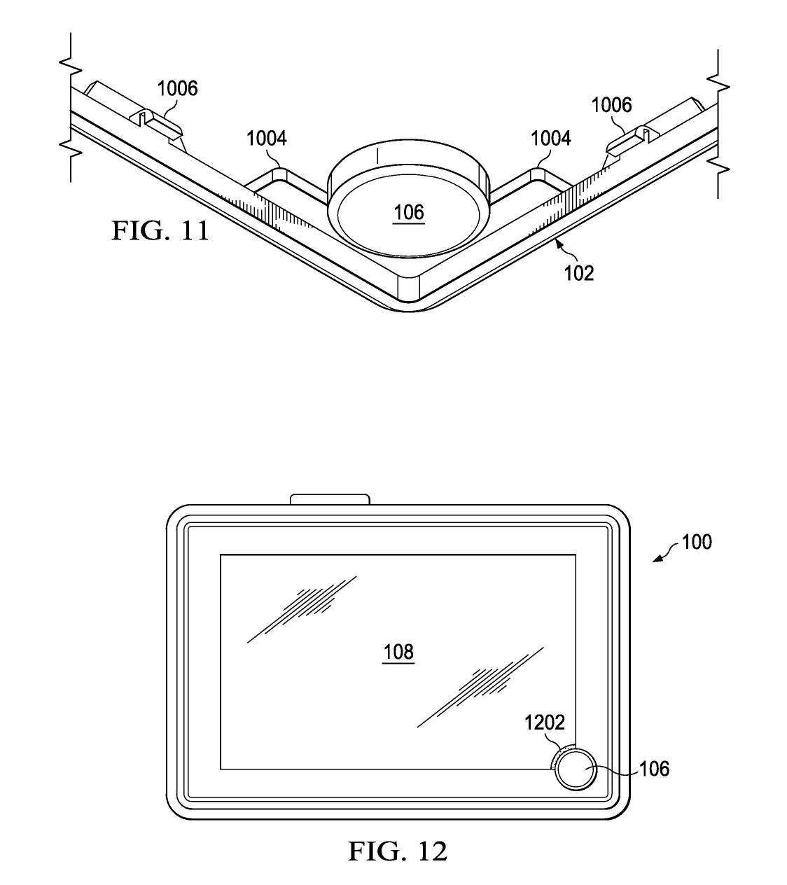

FIG. 11 is an illustration of a top isometric view of the housing 102 (FIG. 1) that includes the optical sensor shield 106 and support frame 1002, as described with regard to FIG. 10. In configuring the electronic display 100 (FIG. 1), the support frame 1002 may be configured with the screen 108 (FIG. 1) and then the housing 102 with the screen frame 104 (FIG. 1) may have the support frame 1002 and screen 108 inserted and/or connected to the housing 102 and/or screen frame 104.

FIG. 12 is an illustration of a front view of the electronic display 100 (FIG. 1). In this embodiment, the electronic display is displaying a visual verification signal 1202 using pixels of the screen 108 (FIG. 1) that are behind and extend beyond (i.e., into a visible region of the screen so that viewers can see) and in approximately the same profile or shape as the outer edge of the optical sensor shield 106 (FIG. 1). The visual verification signal 1202 may operate by flashing on and off, thereby illuminating the optical sensor (not shown) that is positioned in front of the screen 108 and behind the optical sensor shield 106. In one embodiment, the visual verification signal 1202 is displayed in successive different colors (e.g., three pulses of red, three pulses of green, three pulses of blue). Alternatively, a single color may be displayed.

So that people can see the visual verification signal operating, a small number of pixels immediately adjacent to and extending beyond the optical sensor shield 106 may be designated to display the visual verification signal. In one embodiment, the pixels beyond the optical sensor shield 106 may be in approximately the same shape as the border of the optical sensor shield 106, in this case circular. It should be understood that the number of pixels may be ten or fewer, which is enough to be noticed, but not enough to be distracting to a viewer of the content being displayed on the electronic display. Depending on the size of the pixels and size of the screen 108, the number of pixels that are visible beyond the optical sensor shield 106 may vary for aesthetic and viewer distraction reasons.

Other visual verification signal display shapes may be utilized in accordance with the principles of the present invention. By displaying the visual verification signal 1202 slightly beyond the optical sensor shield 106, viewers, including operators of the electronic display 100, may come to recognize the visual verification signal 1202 configuration as a technique that is being used to verify correctness and timeliness of the content being displays. In addition, the visual verification signal 1202 in combination with the optical sensor shield 106 may provide an ornamental feature for the electronic display 100.

The previous description is of a preferred embodiment for implementing the invention, and the scope of the invention should not necessarily be limited by this description. The scope of the present invention is instead defined by the following claims.

We claim:

1. An electronic display, comprising:
a screen including an outer perimeter and front surface;
a housing including a screen frame that surrounds the outer perimeter and extends in front of the front surface of the screen; and
an optical sensor shield that is positioned at least in part in the screen frame and extends in front of the front surface of said screen.

2. The electronic display according to claim 1, wherein the optical sensor shield is not coplanar with the screen frame.

3. The electronic display according to claim 1, further comprising a support frame that connects to said optical sensor shield and is positioned under the screen frame.

4. The electronic display according to claim 1, further an optical sensor disposed between said optical sensor shield and said screen.

5. The electronic display according to claim 4, further comprising pixels being designated for displaying a visual content signal to illuminate said optical sensor.

6. The electronic display according to claim 5, wherein said pixels include pixels that are beneath said optical sensor shield and are immediately adjacent to an outer perimeter of said optical sensor shield.

7. The electronic display according to claim 6, wherein the pixels that are immediately adjacent to an outer perimeter of said optical sensor shield for approximately the same shape as the outer perimeter of said optical sensor shield that extends in front of said screen.

8. A method for displaying a visual verification signal, said method comprising:
designating a plurality of pixels of a screen that are positioned below and immediately adjacent to an outer perimeter of an optical sensor shield; and
displaying a visual verification signal in the designated pixels.

9. The method according to claim 8, wherein designating the plurality of pixels includes designating pixels that substantially match a shape defined by the outer perimeter of the optical sensor shield.

10. The method according to claim 8, wherein the shape is substantially circular.

11. The method according to claim 8, wherein displaying the visual verification signal includes displaying the visual verification signal in sequential different colors.

12. The method according to 8, wherein displaying the visual verification signal includes turning the designated pixels on and off.

13. A method of manufacturing an electronic display, comprising:
providing a housing;
providing a screen frame;
providing an optical sensor shield;
providing an electronic display screen; and
assembling the housing, screen frame, optical sensor shield, and electronic display screen to form the electronic display.

14. The method according to claim 13, wherein the optical sensor shield is integrated with the screen frame.

15. The method according to claim 13, further comprising mounting an optical sensor between the optical sensor shield and electronic display screen.

16. The method according to claim 13, further comprising routing wires connected to the optical sensor within a channel defined by the optical sensor shield.

17. The method according to claim 13, further comprising connecting an antenna cover to the housing.
